(19) United States
(12) Patent Application Publication
(10) Pub. No.: US 2006/0152330 A1
(43) Pub. Date: Jul. 13, 2006

(54) PTC current limiting device having molding part made of insulating material

(76) Inventors: Jong-Sung Kang, Cheongju-si (KR); Ju-Dam Kim, Seoul (KR); Bang-Wook Lee, Cheongju-si (KR); Young-Jun Lee, Seoul (KR); Won-Joon Choe, Cheongju-si (KR); Jun-Koo Han, Seoul (KR)

Correspondence Address: JONES DAY, 222 EAST 41ST ST, NEW YORK, NY, 10017, US

(21) Appl. No.: 11/329,731

(22) Filed: Jan. 10, 2006

(30) Foreign Application Priority Data
Jan. 12, 2005 (KR) 10-2005-0003047
Jan. 12, 2005 (KR) 10-2005-0003045

(51) Int. Cl. H01C 7/13

(52) U.S. Cl. 338/22 R; 338/22 SD

(57) ABSTRACT

Disclosed is a PTC (Positive Temperature Coefficient) current limiting device for limiting a current by use of PTC characteristics, which includes a PTC element having the PTC characteristics; a pair of electrode units arranged on both sides to face each other with the PTC element being interposed therebetween; and a molding part prepared around the PTC element and the electrode units to surround at least an interface region between the PTC element and the electrode units, the molding part being made of elastic insulating material. The molding part is made of an elastic insulating material or any insulating materials selected from vacuum, gas and oil. Thus, this device may effectively restrain an arc generated while limiting overcurrent or short circuit current, and also prevent flashover between electrodes.

### BACKGROUND OF THE INVENTION

1. Field of the Invention

The present invention relates to a PTC (Positive Temperature Coefficient) current limiting device, and more particularly a PTC current limiting device capable of preventing arc generated between a PTC element and a contact electrode or flashover between contact electrodes.

2. Description of the Related Art

Generally, a circuit breaker is widely used for preventing a short circuit of a high or low voltage system. A frequency of electricity currently used is 60 Hz, and its one phase may be changed into 16.7 ms. If such one phase is defined as one cycle, a conventional circuit breaker takes a long time, namely at least several cycles for circuit breaking, and does not have a current limiting function against an estimated fault current value, so a ripple effect for the fault is lasting relatively longer. In addition, in case of failing to break a short circuit current, serious effects are given to surrounding power equipments and systems. Thus, there is an increased need for a current limiting technique that is capable of effectively limiting a short circuit current of a system in a short time.

For the current limiting technique, a current limiting device is representatively used. The current limiting device is used for limiting or breaking overcurrent or short circuit current generated in a power system, and it may achieve its function using a PTC (Positive Temperature Coefficient) element.

A material having the PTC characteristic has a relatively low resistance at a normal temperature to pass an electric current well. However, if a temperature of surroundings is increased or the material is heated by itself due to the introduction of a current over an allowable value, the resistance is abruptly increased several hundred times or more, thereby capable of limiting the current. Thus, if a circuit element is configured using the above material, various circuits may be protected when a temperature rises.

In this connection, Japanese Patent Publication H10-321413 discloses a current limiting device using PTC. Referring to FIG. 1 related to the above, the conventional PTC current limiting device includes a PTC polymer element 1 having a PTC characteristic by mixing conductive particles therein, first electrodes 2, 3 arranged on both surfaces of the PTC polymer element 1 by welding, and second electrodes 4, 5 arranged on the surfaces of the first electrodes 2, 3 to be electrically connected thereto.

At this time, the current limiting device has conditions that the PTC polymer element 1 has a surface area greater than the first electrodes 2, 3, and the first electrodes 2, 3 have a surface area greater than the second electrodes 4, 5. In this configuration, an internal short circuit occurring at both ends of the first electrodes 2, 3 may be prevented, and a change of resistance of the current limiting device before or after the current limiting device is operated may be reduced so that a current with great load may be applied thereto. In addition, frames 6, 7 made of insulating materials are installed around the PTC polymer element 1 to elongate an insulating distance so as to prevent flashover between the first electrodes 2, 3 and the second electrodes 4, 5.

However, in case the conventional current limiting device is substantially used for limiting a short circuit current over 100V and 10 kA, the PTC polymer element 1 and the first electrodes 2, 3 contacting with the PTC polymer element 1 show time difference and nonlinearity of the generated resistances due to the difference of thermal capacity of them. Thus, a significant resistance is generated in the interface of the PTC polymer element 1 and the first electrodes 2, 3 prior to a resistance caused by heating of the PTC polymer element 1. Accordingly, a thermal stress is concentrated to generate an arc in the interface between the PTC polymer element 1 and the first electrodes 2, 3, together with serious noise. Such an arc decomposes and carbonizes the PTC polymer element 1, resulting in dielectric breakdown in the end. In addition, PTC materials are melt and evaporated due to such an arc and the heat of the PTC polymer element 1 itself so that the PTC polymer element 1 becomes gradually thinner and the first electrodes 2, 3 are soaked in the PTC polymer element 1.

Accordingly, the conventional current limiting device is intended to increase a contact pressure using a pressing structure for controlling surface areas of the first and second electrodes 2, 3, 4, 5, but arc generation caused by electron repelling power and time difference of resistances generated in the interface with the PTC polymer element 1 cannot be avoided, and also it is not easy to avoid deterioration of current limiting features and flashover between electrodes due to the generated arc.

In addition, the frames 6, 7 made of insulating materials and installed to both ends of the PTC polymer element 1 proposed in the prior art are useful for obtaining an insulating distance, but they cannot eliminate an arc generated in the PTC polymer element 1 and the first electrodes 2, 3, and also it is not expected that noise generated during a breaking operation is lessened.

Due to the above reasons, the conventional current limiting device is capable of limiting a current without noise and arc at a low current region, but it cannot avoid arc generation in a high current or high capacity system and also the arc causes deterioration of the PTC element and shortening of its life.

### SUMMARY OF THE INVENTION

The present invention is designed to solve the problems of the prior art, and therefore it is an object of the present invention to provide a PTC current limiting device that may be used in a high voltage system as well as in a low voltage system since it may effectively restrain an arc generated while limiting overcurrent or short circuit current and it may also prevent flashover between electrodes.

In order to accomplish the above object, the present invention provides a PTC (Positive Temperature Coefficient) current limiting device, which limits a current by use of PTC characteristics, the device including: a PTC element having the PTC characteristics; a pair of electrode units arranged on both sides to face each other with the PTC element being interposed therebetween; and a molding part made of an insulating material prepared around the PTC element and the electrode units to at least partially surround the PTC element and the electrode units. Here, the molding part may be an elastic insulating material or any insulating material selected from the group consisting of vacuum, gas and oil.

In another aspect of the invention, there is also provided a PTC current limiting device, which limits a current by use of PTC characteristics, the device including: a PTC element having the PTC characteristics; a pair of electrode units arranged on both sides to face each other with the PTC element being interposed therebetween; and a molding part prepared around the PTC element and the electrode units to surround at least an interface region between the PTC element and the electrode units, the molding part being made of elastic insulating material.

Preferably, the molding part is made of a thermosetting or thermoplastic resin having an insulation resistance of 10³ to 10²⁰ ohms and an elongation of 5% or more.

In addition, the elastic insulating material is preferably made of silicone resin or polyurethane resin.

In still another aspect of the invention, there is also provided a PTC current limiting device for limiting a current using PTC characteristics, the device including: a PTC element having the PTC characteristics; a pair of electrode units arranged on both sides to face each other with the PTC element being interposed therebetween; and a molding part including a first insulator made of floating insulating material and adjacently prepared to at least partially surround the PTC element and the electrode units, and a second insulator prepared to surround the first insulator

Preferably, the floating insulating material is one selected from the group consisting of vacuum, gas, and oil.

In case the floating insulating material is composed of a vacuum, the first insulator preferably has the degree of a vacuum of 10⁻³ torr or less. In case the floating insulating material is composed of a gas, the first insulator is preferably SF₆, N₂, or their mixture gas of 1 bar or above. In case the floating insulating material is composed of an oil, the first insulator is preferably an insulating oil with a cooling ability.

Also preferably, the electrode unit includes a contact electrode contacting with the PTC element; and a current lead connected to the contact electrode to apply a current of an external circuit to the contact electrode, wherein the molding part surrounds the entire PTC element, the entire contact electrode, and a part of the current lead.

Furthermore, the PTC element may include at lease one polymer selected from the group consisting of HDPE (High Density Polyethylene), LDPE (Low Density Polyethylene), epoxy, silicone, and PVDF (Polyvinyl Difluoride); at least one type of conductive particles selected from the group consisting of carbon, metal and metal oxide; and an antioxidant.

Meanwhile, the PTC current limiting device according to this embodiment may further include a pressing means for pressing the electrode units toward the PTC element, and the pressing means preferably gives a pressing force equal to or greater than an atmospheric pressure.

At this time, the pressing means preferably includes a housing that receives the molding part; and an elastic member elastically biased by an inner surface of the housing so as to press at least one side of the molding part toward the PTC element.

As an alternative, the pressing means may also include a pair of plates arranged so that the molding part is interposed between them; and a coupling member for coupling and fixing the pair of plates with each other.

### BRIEF DESCRIPTION OF THE DRAWINGS

Other objects and aspects of the present invention will become apparent from the following description of embodiments with reference to the accompanying drawing in which:

FIG. 1 is a sectional view showing a conventional PTC current limiting device;

FIG. 2 is a sectional view showing a PTC current limiting device according to a first embodiment of the present invention;

FIG. 3 is a sectional view showing a modification of the PTC current limiting device according to the first embodiment of the present invention;

FIG. 4 is a sectional view showing another modification of the PTC current limiting device according to the first embodiment of the present invention;

FIG. 5 is a sectional view showing still another modification of the PTC current limiting device according to the first embodiment of the present invention;

FIG. 6 is a sectional view showing a PTC current limiting device according to a second embodiment of the present invention;

FIG. 7 is a sectional view showing a modification of the PTC current limiting device according to the second embodiment of the present invention;

FIG. 8 is a sectional view showing a PTC current limiting device according to a third embodiment of the present invention;

FIG. 9 is a sectional view showing a modification of the PTC current limiting device according to the third embodiment of the present invention;

FIG. 10 is a graph showing a waveform during the breaking operation of the PTC current limiting device according to the present invention when an overcurrent is applied.

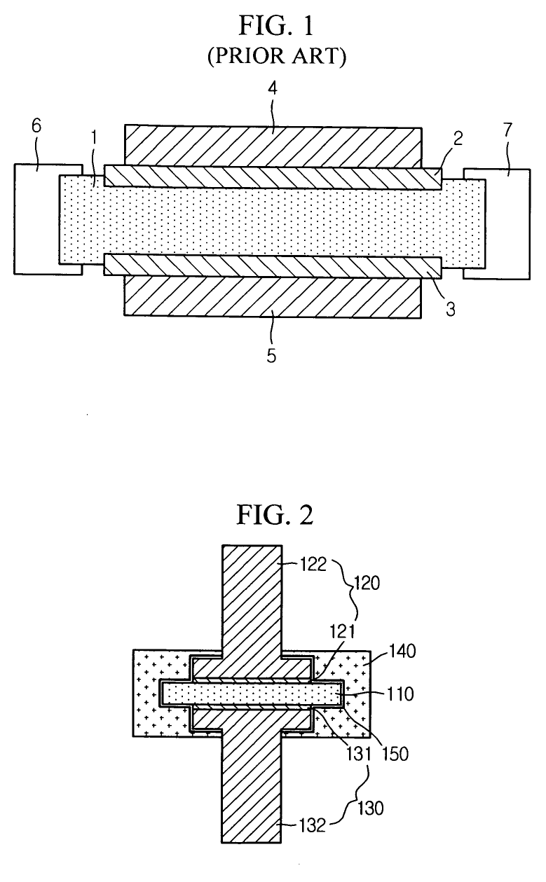

### DESCRIPTION OF THE PREFERRED EMBODIMENT

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 2 is a sectional view showing a PTC (Positive Temperature Coefficient) current limiting device according to a first embodiment of the present invention.

Referring to FIG. 2, the PTC current limiting device of this embodiment includes a PTC element 110, a pair of electrode units 120, 130 arranged so that the PTC element 110 is interposed between them, and a molding part 140 prepared around the PTC element 110 and the electrode units 120, 130.

The PTC element 110 is used for restraining overcurrent in a power system by abruptly increasing an electric resistance at a specific temperature value as a temperature of surroundings rises.

The PTC element 110 may have different properties according to a current to be limited, but in this embodiment the PTC element 110 preferably has a specific resistance of 100 Ωm or below at 25° C., and the specific resistance at a switching temperature that Joule heat is generated due to the supply of current preferably becomes at least 10⁵ times as great as that at 25° C. In addition, the PTC element 110 should be designed to endure a voltage of AC 100V or above with keeping electrical and thermal stability and not to generate flashover when overcurrent of 30 kV or above per 1 cm is applied. Moreover, when being put into a circuit, the PTC element 110 should not be tripped at the time that a current of about 1 A is applied thereto so that an ordinary current, for example about 1 A, may be applied thereto. In addition, when an overcurrent more than 10 times of a normal operation current is applied, the PTC element 110 should cause a rise of resistance within ½ cycle (here, one cycle is 16.7 ms) to limit the overcurrent. Moreover, the PTC element 110 is preferably fabricated so that an operation time should be faster as a magnitude of a short circuit current is greater, and also it may restore its initial state within several minutes after the overcurrent limiting operation.

Preferably, the PTC element 110 has a plate structure, and it may have a circular, oval or polygonal shape. In addition, its area and thickness are preferably designed in consideration of use conditions, namely various factors such as an ordinary current, an overcurrent to be limited, and an operation time.

The PTC element 110 is preferably composed of polymer having PTC characteristics. The PTC polymer has a structure where conductive particles are impregnated in a crystalline or semi-crystalline polymer having an amorphous area and a crystalline area. If a current over a certain vale is supplied to the PTC polymer to cause Joule heat, the PTC polymer is changed from a normal temperature state to a high temperature state. Due to the rise of temperature, the polymer shows expansion of volume as the crystalline area comes into an amorphous state. At this time, conductive particles move their positions so that their connections are sporadically cut, and thus the entire resistance of the element becomes abrupt increased.

The polymer may be at least one polymer selected from the group consisting of HDPE (High Density Polyethylene), LDPE (Low Density Polyethylene), epoxy, silicone, and PVDF (Polyvinyl Difluoride). In addition, the conductive particles may have at least one type of conductive particles selected from the group consisting of carbon, metal and metal oxide (TiB₂).

In addition, an antioxidant may be further added so as to prevent oxidization of the PTC polymer. Furthermore, an inorganic additive may be further added to the PTC polymer so as to improve a low resistance characteristic at a normal temperature and a high resistance characteristic at a high temperature further.

The electrode units 120, 130 includes contact electrodes 121, 131 contacting with the PTC element 110, and current leads 122, 132 for applying a current of an external circuit to the contact electrodes 121, 131.

The contact electrodes 121, 131 may be composed of copper foil or other metal elements. In addition, the contact electrodes 121, 131 are attached to both sides of the PTC element 110 in a way of reducing a contact resistance to the minimum by using lamination or free contact as examples.

A contact area of the contact electrodes 121, 131 is preferably determined in consideration of area and thickness of the PTC element 110 so that flashover does not occur between the contact electrodes 121, 131 while the PTC element 110 is in operation.

The current leads 122, 132 are connected to the contact electrodes 121, 131 to electrically connect the contact electrodes 121, 131 with a power system. In more detail, the current leads 122, 132 are extended so that their one ends are electrically connected to the contact electrodes, and the other ends are connected to an external circuit. In addition, the current leads 122, 132 are preferably made of metal materials and have sectional area and thickness suitable for a current capacity of the system.

More particularly, the current limiting device may further include a connection electrode (not shown) interposed between the contact electrodes 121, 131 and the current leads 122, 132. The connection electrode is made of metal such as gold and silver having a relatively lower resistance so that a current may be more easily applied from the power system to the current limiting device.

The molding part 140 is configured to wrap an interface portion between the PTC element 110 and the contact electrodes 121, 131. That is to say, the molding part 140 is molded around the PTC element 110, the contact electrodes 121, 131, and the current leads 122, 132. The molding part 140 is made of insulating material with elasticity. Preferably, the molding part 140 has an insulating resistance of 1⁰³ to 10²⁰ ohms so as to give a sufficient dielectric strength. In addition, in order to flexibly cope with an instant impact generated during the current limiting operation and thus prevent the molding part 140 from being broken, the molding part 140 preferably has an elongation of at least 5%. This molding part 140 is composed of thermosetting or thermoplastic resin, and for example silicone resin, polyurethane and the like may be used. However, the present invention is not limited thereto.

If the PTC element 110 operates due to overcurrent, an arc is instantly generated in the interface of the contact electrodes 121, 131, and this arc may deteriorate and damage the characteristics of the PTC element 110. In addition, if arcs are repeatedly generated, the performance of the PTC element 110 may be deteriorated much more not to be used any more. However, in the present invention, the molding part 140 directly surrounding the PTC element 110 instantly absorbs and disappears instant impact energy and initial arc generated in the interface between the PTC element 110 and the contact electrodes 121, 131 when the PTC element 110 conducts the current limiting operation.

In addition, when the PTC element 110 operates for limiting a current, an arc generated in the interface between the PTC element 110 and the contact electrodes 121, 131 at both ends may jump over the PTC element 110 and cause flashover between the contact electrodes 121, 131 at both ends. Thus, it is important to ensure an insulating distance not causing flashover. In the present invention, a sufficient insulating distance may be ensured between both ends of the PTC element 110 since the molding part 140 is configured to surround the entire PTC element 110, the entire contact electrodes 121, 131, and a part of the current leads 122, 132. That is to say, a significant dielectric strength is ensured around the contact electrodes 121, 131, so flashover may be prevented.

Furthermore, the molding part 140 seals a space caused by incomplete contact between the PTC element 110 and the contact electrodes 121, 131, thereby capable of improving a contact resistance characteristic.

Preferably, the PTC current limiting device of this embodiment further includes a coating layer 150 interposed between the PTC element 110 or the electrode units 120, 130 and the molding part 140. The coating layer 150 is added to improve an interfacial connection between the molding part 140 and the PTC element 110 and between the molding part 140 and the electrode units 120, 130. Silicone resin, polyurethane resin or epoxy resin may be used for the coating layer 150, for example. However, the present invention is not limited thereto.

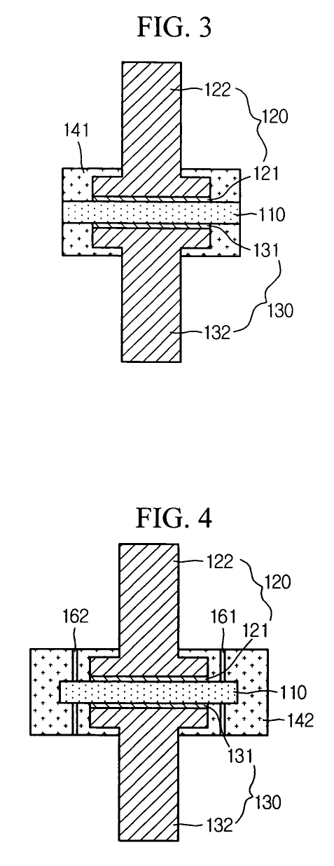

The PTC current limiting device of this embodiment may modify the shape of the molding part in various ways within the scope of the invention, as shown in FIG. 3 as an example. Referring to FIG. 3, a molding part 141 of the PTC current limiting device according to this modification may be configured so as to surround the PTC current limiting device 110 with its surrounding surface being exposed.

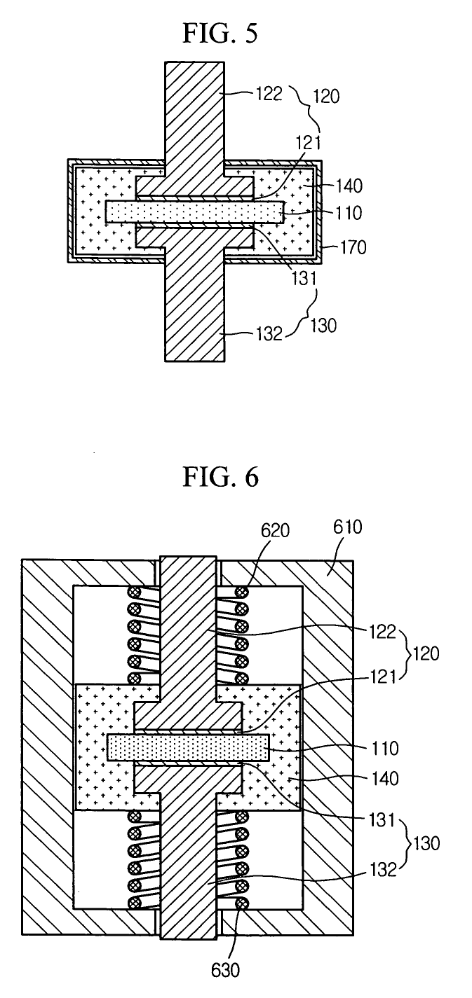

In addition, FIGS. 4 and 5 are sectional views showing other modifications of the PTC current limiting device of this embodiment. In FIGS. 4 and 5, the same reference numeral as in the former drawings designates the same component having the same function, and not described in detail.

Referring to FIG. 4 first, a molding part 142 of the PTC current limiting device according to this modification has gas exhaust holes 161, 162. When the PTC current limiting device conducts a current limiting action, the PTC element 110 may be dissolved to generate gas. Such dissolution gas contains carbonized conductive metal particles, and if the conductive metal particles are adsorbed to the PTC element 110, a carbonized conductive path is formed to give a bad effect on insulation. In addition, in case a dissolution gas instantly occurs during the current limiting operation, an inner pressure is raised due to the dissolution gas, which may make the molding part 140 with elasticity be expanded excessively. At this time, the gas exhaust holes 161, 162 formed in the molding part 142 may discharge the dissolution gas of the PTC element 110 to outside, thereby solving the above problems.

At least one gas exhaust hole 161, 162 may be prepared so that the dissolution gas of the PTC element may be discharged more effectively.

Meanwhile, referring to FIG. 5, the PTC current limiting device of this modification further includes a case 170 prepared to receive the molding part 140. The case 170 supports the structure of the molding part 140, and restrains excessive expansion of the molding part 140 during the current limiting operation. In addition, the case 170 protects the molding part 140 against external environments such as light, moisture and pollution sources.

This case 170 may be made of materials having an insulating property such as polyethylene, polypropylene or bakelite. However, the present invention is not limited to the above, but various changes may be possible within the scope of the invention by those having ordinary skill in the art.

FIG. 6 shows a PTC current limiting device according to a second embodiment of the present invention. In FIG. 6, the same reference numeral as in the former drawings designates the same component having the same function, and not described in detail.

Referring to FIG. 6, the PTC current limiting device of this embodiment further includes a pressing means for pressing the electrode units 120, 130 toward the PTC element 110. The pressing means includes a housing 610, and elastic members 620, 630.

The housing 610 receives the molding part 140, and in this way receives the entire PTC element 110, the entire contact electrodes 121, 131, and a part of the current leads 122, 132. A part of the current leads 122, 132 is extended outward through the housing 610 and connected to a power system.

The elastic members 620, 630 are supported against an inner surface of the housing 610, and they are configured to surround outer circumferences of the current leads 122, 132 and press the molding part 140 so that the current leads 122, 132 are pressed toward the contact electrodes 121, 131. In this way, the contact electrodes 121, 131 are pressed toward the PTC element 110. Preferably, the elastic members 620, 630 may be prepared to any or both of the current leads 122, 132.

Meanwhile, it is preferred that a pressing force of the elastic members 620, 630 is set to be at least 1 bar so as to cope with the separation of interfaces between the PTC element 110 and the contact electrodes 121, 131 caused by electron repelling force generated at a short circuit fault. In addition, it is also preferable that the pressing force of 1 bar or more is kept even when the thickness of the PTC element 110 is decreased to a half due to repeated current limiting operations.

The elastic members 620, 630 may be composed of coil springs prepared to surround the outer circumference of the current lead 122 and/or 132, for example. However, the present invention is not limited to the above, but various changes will be possible within the scope of the invention by those skilled in the art.

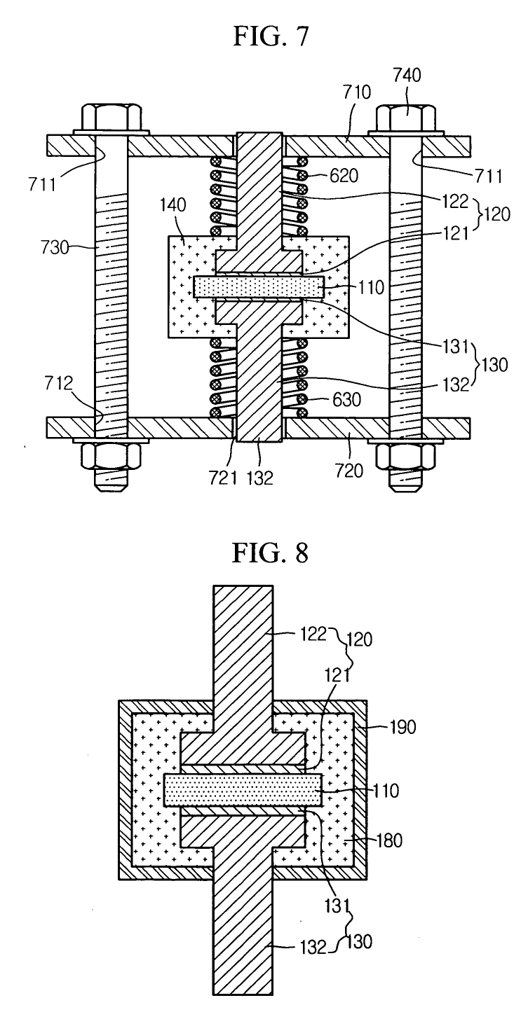

FIG. 7 shows a modification of the PTC current limiting device according to this embodiment. In FIG. 7, the same reference numeral as in the former drawings designates the same component having the same function, and not described in detail.

Referring to FIG. 7, the pressing means of the PTC current limiting device of this modification includes upper and lower plates 710, 720, and a coupling member for coupling the upper and lower plates 710, 720.

The PTC element 110, the contact electrodes 121, 131, and the current leads 122, 132 are arranged between the upper and lower plates 710, 720, and the upper and lower plates 710, 720 have a through hole 721 at their centers so that the current leads 122, 132 are connected to an external circuit.

The upper and lower plates 710, 720 have coupling holes 711, 712 in their edges, and thus the coupling members fix the upper and lower plates 710, 720 with each other through the coupling holes 711, 712. Specifically, bolts 730 pass through the coupling holes 711, 712, and nuts 740 are coupled to the bolts 730 to fix the upper and lower plates 710, 720 with each other.

Preferably, the pressing means further includes elastic members 620, 630 prepared to surround the current leads 122, 132. The elastic members 620, 630 are supported against inner sides of the plates 710, 720, and they are compressed along the outer circumferences of the current leads 122, 132 and then elastically biased. Accordingly, the elastic members 620, 630 press the molding part 140 so that the contact electrodes 121, 131 may press the PTC element 110. A pressing force of the elastic members 620, 630 is substantially identical to that of the former embodiment.

Meanwhile, in FIG. 7, the elastic members 620, 630 are arranged to both current leads 122, 132, but they may be arranged to any of them when required.

In addition, though it is shown in FIGS. 6 and 7 that the pressing means is applied to the PTC current limiting device having the molding part 140 as shown in FIG. 2, such a pressing means may also be applied in the same way to the PTC current limiting device shown in FIGS. 3 to 5, which have a molding part with different structures.

Though the detailed configuration of the pressing means has been explained in the above embodiments, the present invention is not limited thereto, but it should be understood that various changes of a pressing means capable of pressing the electrode units 120, 130 toward the PTC element 110 may be used.

FIG. 8 shows a PTC current limiting device according to a third embodiment of the present invention. In FIG. 8, the same reference numeral as in the former drawings designates the same component having the same function, and not described in detail.

Referring to FIG. 8, the PTC current limiting device of this embodiment has a molding part with a structure different from the PTC current limiting device of the first embodiment. That is to say, the molding part of this embodiment includes a first insulator 180 made of floating insulating material, and a second insulator 190 prepared to surround the first insulator 180.

The first insulator 180 may be configured to surround the entire PTC element 110, the entire contact electrodes 121, 131, and a part or all of the current leads 122, 132. Thus, the first insulator 180 may give a more effective function of preventing arc generation or flashover.

The first insulator 180 is configured to directly surround the PTC element 110 so that arc and noise generated between the PTC element 110 and the contact electrodes 121, 131 may be removed. That is to say, the first insulator 180 instantly absorbs instant impact energy and initial arc generated in the interface between the PTC element 110 and the contact electrodes 121, 131 during the operation of the PTC element 110, and then disappears them. Thus, arc and noise are hardly generated. In addition, since the first insulator 180 is made of floating insulating material, a space caused by incomplete contact between the PTC element 110 and the contact electrodes 121, 131 may be sealed, thereby lowering generation of arc.

In addition, the first insulator 180 may ensure an insulating distance between the contact electrodes 121, 131 at both ends. As mentioned above, when the PTC element 110 operates for limiting a current, an arc is instantly generated in the interface between the PTC element 110 and the contact electrodes 121, 131 at both ends. If this arc is not restrained, the arc may jump over the PTC element 110 and cause flashover between the contact electrodes 121, 131 at both ends. Thus, it is important to ensure an insulating distance not causing flashover. In this embodiment, a sufficient insulating distance may be ensured between both ends of the PTC element 110 since the first insulator 180 is configured to surround the entire PTC element 110, the entire contact electrodes 121, 131, and a part or all of the current leads 122, 132. That is to say, a significant dielectric strength is ensured around the contact electrodes 121, 131, so flashover may be prevented.

In addition, in an overheated state after the current limiting operation, the PTC element 110 may be cooled into a normal temperature state in a short time by means of the first insulator 180.

Specifically, the floating insulating material for the first insulator 180 may be composed of a vacuum. More specifically, the vacuum is a vacuum layer having a degree of vacuum of 10⁻³ torr or less. The vacuum has at least 10 times of dielectric strength rather than a general air. In addition, since there is no medium for transferring energy in a vacuum state, it is possible to prevent any further progress of dielectric breakdown. Thus, if the first insulator 180 is composed of a vacuum, a great dielectric strength at a vacuum may be realized. In addition, by using the fact that an arc is rapidly disappeared into the vacuum, the arc may be vanished, and also the insulator may be configured with a smaller weight.

As an alternative, the floating insulating material for the first insulator 180 may be composed of a gas. Preferably, the gas may be SF₆ gas or N₂ gas of 1 bar or above.

The SF₆ gas is an inert gas, which is odorless, harmless, nontoxic, nonflammable and non-explosive, gives less dielectric or leakage losses, and is thermally stable. Its dielectric strength is 89 kV/cm, which is far greater than that of an atmospheric air with a dielectric strength of 30 kV/cm. In addition, its dielectric constant is less than that of a solid insulating material, thereby requiring less charging current, and also a shape of the insulating material may be more freely selected rather than a solid insulating material.

The N₂ gas is a main component of the air and also it is a non-combustible gas like the SF₆ gas. In addition, the N₂ gas is economical since it may be obtained easily.

More preferably, the gas may be a SF₆—N₂ mixture gas of 1 bar or above. This gas, obtained by adding the SF₆ gas with the N₂ gas that is a main component of the air and shows excellent chemically stability such as nontoxic and non-combustible properties together with a low boiling point and a low price, shows less deterioration of dielectric strength due to the presence of impurities or roughness of the electrode surface, and also it may be used as a more economic insulating gas in views of low boiling point and low cost.

As another alternative, the floating insulating material for the first insulator 180 may be composed of an oil.

Preferably, the oil may be an insulating oil not containing impurity but having a cooling ability, and also it may be a mineral oil containing hydrocarbon in a naphthene, paraffin, or benzol family as a main component. The cooling ability is defined as that the PTC element 110 may restore its normal state in 3 minutes after its operation.

Though specific examples of the floating insulating material have been disclosed in the above, it should be understood that the present invention is not limited thereto but many changes may be used.

The second insulator 190 plays a role of case to support and keep a shape of the first insulator 180 that may be expanded during the current limiting operation. In addition, the second insulator 190 protects the first insulator 180 against external environments such as light, moisture and polluting sources. Thus, the second insulator 190 is preferably configured to completely seal the first insulator 180 from outside.

The second insulator 190 may be composed of material having an insulating property such as polyethylene, polypropylene or bakelite. However, the present invention is not limited to the above, but various changes are possible within the scope of the invention by those skilled in the art.

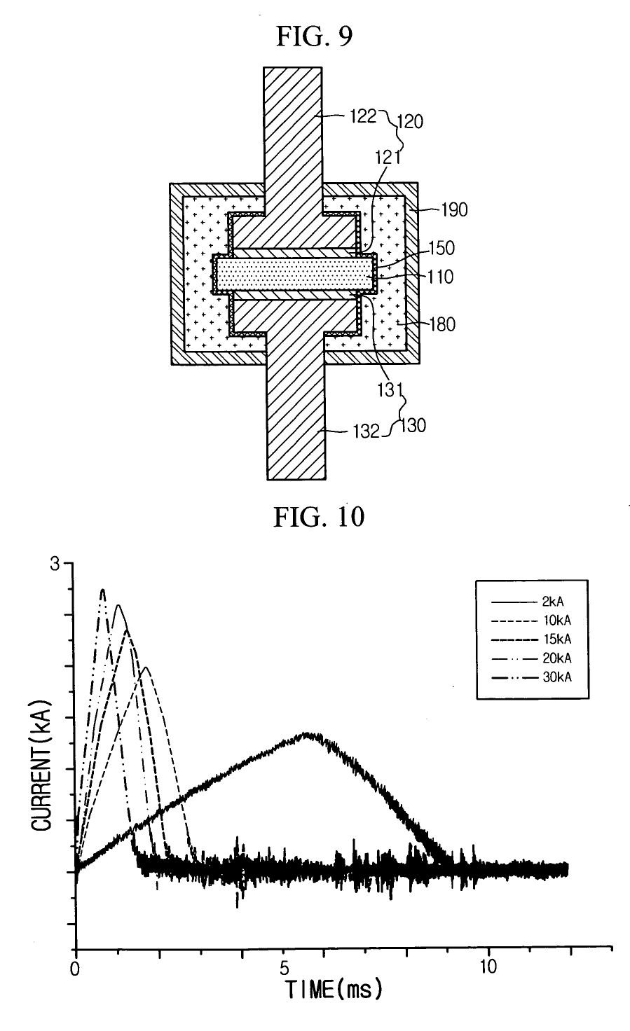

FIG. 9 is a sectional view schematically showing a modification of the PTC current limiting device according to this embodiment. In FIG. 9, the same reference numeral as in the former drawings designates the same component having the same function, and not described in detail.

Referring to FIG. 9, the PTC current limiting device of this modification further includes a coating layer 150 interposed between the PTC element 110 or the electrode units 120, 130 and the first insulator 180.

When the first insulator 180 surrounds the PTC element 110, air bubbles may be generated their interface. Then, a dielectric breakdown may progress along the air bubbles when the PTC element 110 operates, which is apt to make the first insulator 180 not functioning well. At this time, if the coating layer 150 is prepared on the interface, the first insulator 180 may be closely adhered to the surface of the PTC element 110 in an easier way, so the PTC current limiting device may operate more effectively.

Preferably, the coating layer 150 may be made by coating epoxy or silicone rubber. However, the present invention is not limited to the above, but various changes are possible within the scope of the invention by those skilled in the art.

FIG. 10 is a graph showing a waveform of the breaking operation of the PTC current limiting device according to the present invention when an overcurrent is applied thereto, and this PTC current limiting device is manufactured according to the embodiment shown in FIG. 2. In this experiment, a voltage of 400V was applied to both ends of the PTC element, and a current limiting characteristic was examined with applying a fault current varying from 2 kV to 30 kV. Referring to FIG. 10, it may be found that the current limiting action is made rapidly and accurately not only in case a low current of 2 kA flows but also in cases high currents of 10 kA, 15 kA, 20 kA and 30 kA flow, thereby breaking the overcurrent effectively.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

As described above, the PTC current limiting device of the present invention may effectively restrain and eliminate an arc generated between the PTC element and the contact electrodes when limiting an overcurrent or a short circuit current, thereby preventing flashover between electrodes. Thus, it is possible to prevent abrasion of the PTC element and elongate a life of the PTC current limiting device. In addition, the PTC current limiting device of the present invention may give a reliable current limiting action not only for a low voltage system but also for a high voltage system.

What is claimed is:

1. A PTC (Positive Temperature Coefficient) current limiting device, which limits a current by use of PTC characteristics, the device comprising:
a PTC element having the PTC characteristics;
a pair of electrode units arranged on both sides to face each other with the PTC element being interposed therebetween; and
a molding part prepared around the PTC element and the electrode units to surround at least an interface region between the PTC element and the electrode units, the molding part being made of elastic insulating material.

2. The PTC current limiting device according to claim 1,
wherein the elastic insulating material is a thermosetting or thermoplastic resin having an insulation resistance of 10³ to 10²⁰ ohms and an elongation of 5% or more.

3. The PTC current limiting device according to claim 2, wherein the elastic insulating material is made of silicone resin or polyurethane resin.

4. The PTC current limiting device according to claim 1, wherein the electrode unit includes:
a contact electrode contacting with the PTC element; and
a current lead connected to the contact electrode to apply a current of an external circuit to the contact electrode,
wherein the molding part surrounds the entire contact electrode and a part of the current lead.

5. The PTC current limiting device according to claim 1, wherein the PTC element includes:
at lease one polymer selected from the group consisting of HDPE (High Density Polyethylene), LDPE (Low Density Polyethylene), epoxy, silicone, and PVDF (Polyvinyl Difluoride);
at least one type of conductive particles selected from the group consisting of carbon, metal and metal oxide; and
an antioxidant.

6. The PTC current limiting device according to claim 1, further comprising a coating layer interposed in an interface between the PTC element or the electrode units and the molding part.

7. The PTC current limiting device according to claim 1, wherein a gas exhaust hole is formed in the molding part to communicate the PTC element with an outside.

8. The PTC current limiting device according to claim 1, further comprising a case surrounding an outer surface of the molding part.

9. The PTC current limiting device according to claim 1, further comprising a pressing means for pressing the electrode units toward the PTC element.

10. The PTC current limiting device according to claim 9, wherein the pressing means gives a pressing force equal to or greater than an atmospheric pressure.

11. The PTC current limiting device according to claim 9, wherein the pressing means includes:
a housing that receives the molding part; and
an elastic member elastically biased by an inner surface of the housing so as to press at least one side of the molding part toward the PTC element.

12. The PTC current limiting device according to claim 9, wherein the pressing means includes:
a pair of plates arranged so that the molding part is interposed therebetween; and
a coupling member for coupling and fixing the pair of plates with each other.

13. The PTC current limiting device according to claim 12, further comprising an elastic member elastically biased by an inner surface of the plates so as to press at least one side of the molding part toward the PTC element.

14. A PTC current limiting device for limiting a current using PTC characteristics, the device comprising:
a PTC element having the PTC characteristics;
a pair of electrode units arranged on both sides to face each other with the PTC element being interposed therebetween; and
a molding part including a first insulator made of floating insulating material and adjacently prepared to at least partially surround the electrode units and the PTC element, and a second insulator prepared to surround the first insulator.

15. The PTC current limiting device according to claim 14, wherein the floating insulating material is one selected from the group consisting of vacuum, gas, and oil.

16. The PTC current limiting device according to claim 15,
wherein, in case the floating insulating material is composed of a vacuum, the first insulator has the degree of a vacuum of 10⁻³ torr or less.

17. The PTC current limiting device according to claim 15,
wherein, in case the floating insulating material is composed of a gas, the first insulator is SF₆, N₂, or their mixture gas of 1 bar or above.

18. The PTC current limiting device according to claim 15,
wherein, in case the floating insulating material is composed of an oil, the first insulator is an insulating oil with a cooling ability.

19. The PTC current limiting device according to claim 14, wherein the electrode unit includes:
a contact electrode contacting with the PTC element; and
a current lead connected to the contact electrode to apply a current of an external circuit to the contact electrode,
wherein the molding part surrounds the entire PTC element, the entire contact electrode, and a part of the current lead.

20. The PTC current limiting device according to claim 14, wherein the PTC element includes:
at lease one polymer selected from the group consisting of HDPE, LDPE, epoxy, silicone, and PVDF;
at least one type of conductive particles selected from the group consisting of carbon, metal and metal oxide; and
an antioxidant.

21. The PTC current limiting device according to claim 14, further comprising a coating layer interposed in an interface between the PTC element or the electrode units and the first insulator.

22. A PTC current limiting device for limiting a current using PTC characteristics, the device comprising:
a PTC element having the PTC characteristics;
a pair of electrode units arranged on both sides to face each other with the PTC element being interposed therebetween; and
a molding part adjacently prepared to at least partially surround the electrode units and the PTC element and made of an elastic insulating material or any insulating material selected from the group consisting of vacuum, gas and oil.
